(19) United States
(12) Patent Application Publication
(10) Pub. No.: US 2008/0035219 A1
(43) Pub. Date: Feb. 14, 2008

(54) GAS DELIVERY SYSTEM

(76) Inventors: Edward R. Lee, Martindale, TX (US); Robert C. Jones, Mountain City, TX (US); Jeromey Treg Yowell, Elkhart, IN (US); Randy Scott Wheaton, San Marcos, TX (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/838,357

(22) Filed: Aug. 14, 2007

Related U.S. Application Data
(60) Provisional application No. 60/822,257, filed on Aug. 14, 2006.

(51) Int. Cl. F17D 1/04; B62D 63/04; B67D 5/36

(52) U.S. Cl. 137/597; 141/99; 180/89.1

(57) ABSTRACT

A gas delivery system for a recreational vehicle comprising an inlet hose configured to be connected to a source of gas, a manifold connected to the inlet hose, a plurality of supply hoses connected to the manifold, and a plurality of appliances configured to be positioned within the recreational vehicle, with each one of the appliances being connected to one of the supply hoses. Gas can be supplied to each of the appliances via the inlet hose, the manifold and one of the supply hoses.

### CROSS-REFERENCE TO RELATED APPLICATION

This application claims priority to U.S. Provisional Application No. 60/822,257 filed on Aug. 14, 2006 and entitled GAS DELIVERY SYSTEM.

### FIELD OF THE INVENTION

This invention is applicable to a wide range of gas pressure-regulating applications, but is designed for particularly advantageous use in propane recreational vehicle appliance applications.

### BACKGROUND OF THE INVENTION

FIG. 1 illustrates a prior art recreational vehicle 10 with a gas delivery system 11 for the recreational vehicle 10. The gas delivery system 11 includes a gas inlet 12 configured to be connected to a source of gas (not shown). Typically, the source of gas is a tank or tanks of propane gas for fueling appliances 15 in the recreational vehicle 10. The gas is supplied from the gas inlet 12 to the gas delivery system 11, which includes black iron pipes 13 having T-connectors 14 and elbow connectors 17, and copper tubing 18 being connected at one end to the piping 13 at the T-connectors 14 and at the other end to the appliances 15. The black iron piping 13 and the copper tubing 18 are sized (inside diameter) such that the flow rate is sufficient to all of the appliances 15. FIG. 1A illustrates an alternate prior art recreational vehicle 10 with a gas delivery system 11 for the recreational vehicle 10.

### SUMMARY OF THE PRESENT INVENTION

An aspect of the present invention is to provide a gas delivery system for a recreational vehicle comprising an inlet hose configured to be connected to a source of gas, a manifold connected to the inlet hose, a plurality of supply hoses connected to the manifold, and a plurality of appliances configured to be positioned within the recreational vehicle, with each one of the appliances being connected to one of the supply hoses. Gas can be supplied to each of the appliances via the inlet hose, the manifold and one of the supply hoses.

Another aspect of the present invention is to provide a recreational vehicle comprising a vehicle housing, an inlet hose configured to be connected to a source of gas, a manifold in the vehicle housing and connected to the inlet hose, a plurality of supply hoses running through the vehicle housing, with the plurality of supply hoses being connected to the manifold, and a plurality of appliances positioned within the recreational vehicle, with each one of the appliances being connected to one of the supply hoses. Gas can be supplied to each of the appliances, the inlet hose, the manifold and one of the supply hoses.

Yet another aspect of the present invention is to provide a method of delivering gas in a recreational vehicle comprising providing an inlet hose, connecting an inlet hose to a source of gas, connecting a manifold to the inlet hose, connecting a plurality of supply hoses to the manifold, positioning a plurality of appliances within the recreational vehicle, connecting each one of the appliances to one of the supply hoses, and supplying gas to each of the appliances, the inlet hose, the manifold and one of the supply hoses.

These and other aspects, objects, and features of the present invention will be understood and appreciated by those skilled in the art upon studying the following specification, claims, and appended drawings.

### BRIEF DESCRIPTION OF THE DRAWINGS

The following brief description of the figures, and the related figures themselves, exemplifies a particular preferred embodiment of the invention constituting the best mode presently contemplated. As will be understood, other embodiments of the invention as well as changes and variations in the particular structure shown in these figures are no doubt possible, and may very well suggest themselves to those skilled in the art after studying this disclosure and these figures.

FIGS. 1 and 1A are schematic views of prior art recreational vehicles with gas delivery systems;

FIGS. 2 and 2A are schematic views of recreational vehicles with gas delivery systems of the present invention;

FIG. 3 is a top view of a first embodiment of the gas delivery system of the present invention;

FIG. 4 is a top view of a second embodiment of the gas delivery system of the present invention; and

FIG. 5 is a top view of a third embodiment of the gas delivery system of the present invention.

### DETAILED DESCRIPTION OF PREFERRED EMBODIMENT

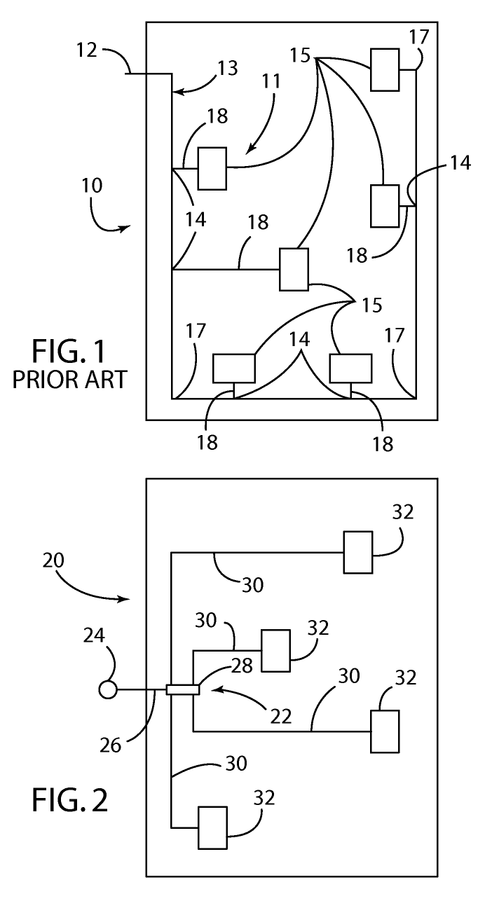

For purposes of description herein, the terms “upper,” “lower,” “right,” “left,” “rear,” “front,” “vertical,” “horizontal,” and derivatives thereof shall relate to the invention as orientated in FIGS. 1 and 1A. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

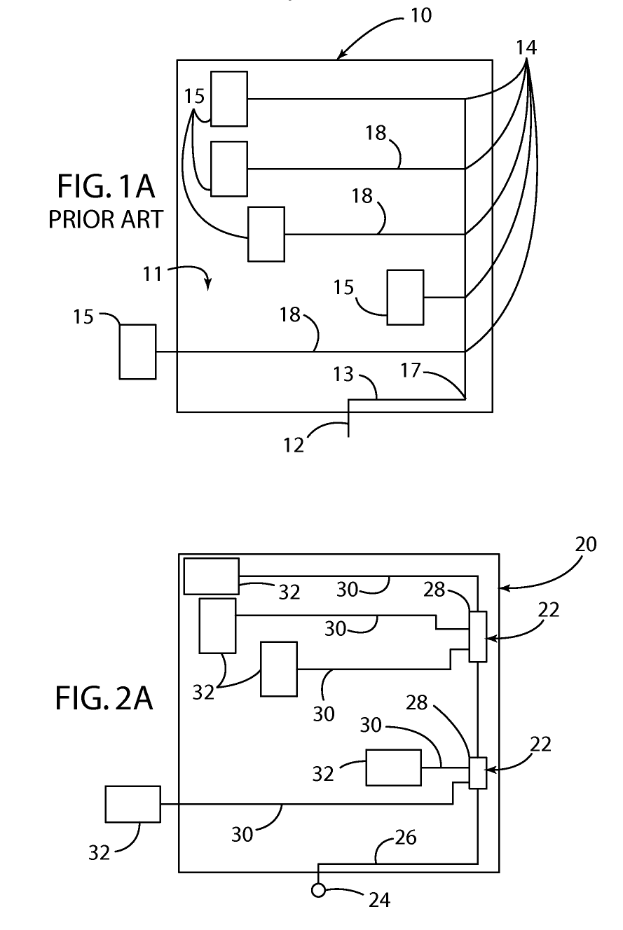

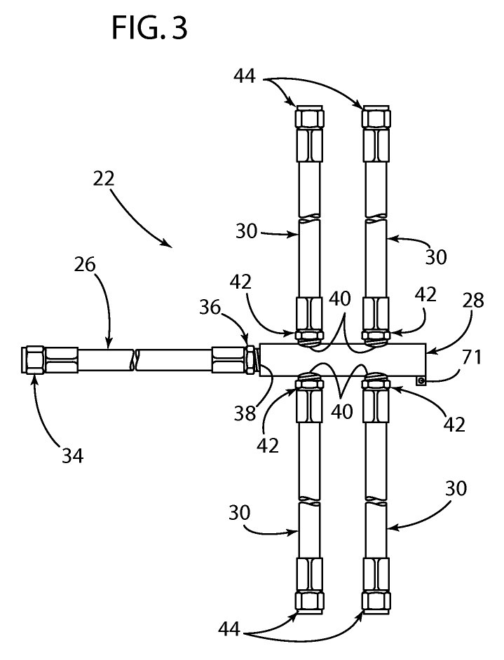

The reference number 20 (FIGS. 2, 2A and 3) generally designate recreational vehicles employing a gas delivery system 22 embodying the present invention. In the illustrated example, the gas delivery system 22 includes a regulator 24 configured to be connected to a source of gas, an inlet hose 26 connected to the regulator 24, a manifold 28 connected to the inlet hose 26, and a plurality of supply hoses 30 connected to the manifold 28 and appliances 32 within the recreational vehicle 20. The regulator 24 can comprise any gas regulator as is well known to those skilled in the art. For example, the regulator 24 can be a Marshall Gas Controls Model 250 automatic changeover or Model 290 integral two-stage regulator as sold by Marshall Gas Controls, a division of S.H. Leggitt Co., of San Marcos Tex. While the gas delivery system 22 is illustrated as being used in the recreational vehicle, it is contemplated that the gas delivery system 22 could be used in any application.

In the illustrated embodiment, the gas delivery system 22 includes the inlet hose 26 connected to the regulator 24 for accepting the gas from the source of gas. The inlet hose 26 is preferably made out of high or low pressure thermoplastic material, although other materials are contemplated. The inlet hose 26 includes a first end 34 configured to be connected to the regulator 24 and a second end 36 configured to be connected to the manifold 28. The first end 34 can have any connection that will allow the inlet hose 26 to be connected to the regulator 24. In the illustrated example, the second end 36 includes a threaded barb (integrally cast or connected to the end) for connection to the manifold 28.

The illustrated manifold 28 supplies gas from the inlet hose 26 to the plurality of supply hoses 30. The manifold 28 can be made from aluminum die casting, zinc die casting, plastic injection molding or in any other method using any material as approved by the cognizant regulatory authority. The manifold 28 includes an inlet connection 38 connected to the inlet hose 26 and a plurality of outlet connections 40 configured to be connected to the supply hoses 30. The illustrated inlet connection 38 is internally threaded to accept the threaded barb of the second end 36 of the inlet hose 26 for connecting the inlet hose 26 to the manifold 28. Furthermore, the manifold 28 can include an excess flow device for preventing excess flow of the gas into the manifold 28 or through the manifold 28 and to the supply hoses 30. For example, the manifold 28 could include the excess flow device disclosed in U.S. patent application Ser. No. 11/338,490 entitled COMBINATION EXCESS-FLOW/BACK-FLOW VALVE, the entire contents of which are hereby incorporated herein by reference. The outlet connections 40 of the present embodiment are also internally threaded. It is also contemplated that the manifold 28 could include a grounding hole 71. The grounding hole 71 is configured to have a copper wire (or other conductive wire) connected thereto (e.g., by a screw), with the other end of the copper wire connected to a metallic frame or other grounded item. The copper wire would help to ground the manifold 28, thereby dissipating any charge that may develop within the manifold 28 and that could be transferred to a metallic manifold. While the grounding hole 71 is shown as being on a projection of the manifold 28, it is contemplated that the grounding hole 71 could be located anywhere on the manifold 28 and could have any shape or size.

In the illustrated example, the supply hoses 30 are connected to the manifold 28 and are configured to supply gas from the manifold 28 to the appliances 32. The supply hoses 30 are preferably made out of high or low pressure thermoplastic material, although other materials are contemplated. The supply hoses 30 include a first end 42 connected to the outlet connections 40 of the manifold 28 and a second end 44 connected to the appliances 32. Grommets may be used to protect any of the hoses that pass through or are adjacent sharp objects that may interfere with a hose as required by nationally recognized installation codes. In the illustrated embodiment, the first end 42 includes a threaded barb on an end thereof for insertion into the internally threaded outlet connections 40 of the manifold 28 to connect the supply hoses 30 to the manifold 28. The supply hoses 30 can be of the same size or can have a different size from at least one of the other supply hoses 30 to allow the supply hoses 30 to have different flow rates. Furthermore, the size, position and number of the outlet connections 40 can be changed as desired.

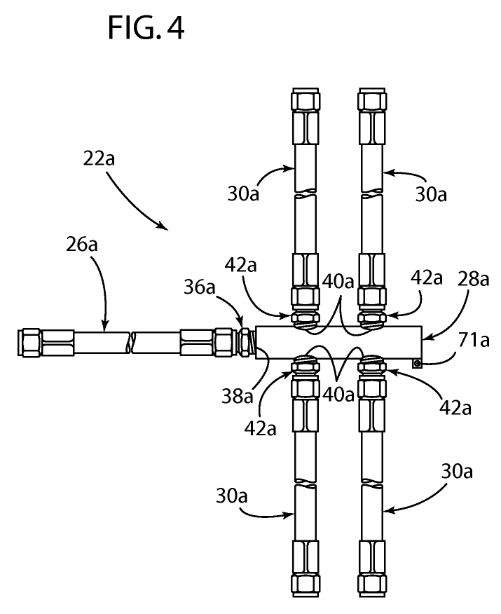

The reference numeral 22a (FIG. 4) generally designates another embodiment of the present invention, having a second embodiment for the gas delivery system. Since gas delivery system 22a is similar to the previously described gas delivery system 22, similar parts appearing in FIGS. 2, 2a and 3 and FIG. 4, respectively, are represented by the same, corresponding reference number, except for the suffix “a” in the numerals of the latter. In the second embodiment of the gas delivery system 22a, SAE male and female threaded connectors are used instead of barbs. Therefore, one of the second end 36a of the inlet hose 26a and the inlet connection 38a of the manifold 28a includes an SAE male threaded connector and the other of the second end 36a of the inlet hose 26a and the inlet connection 38a of the manifold 28a includes an SAE female threaded connector, thereby allowing the inlet hose 26a to be connected to the manifold 28a. Likewise, one of the first end 42a of the supply hoses 30a and the outlet connection 40a of the manifold 28a include an SAE male threaded connector and the other of the first end 42a of the supply hoses 30a and the outlet connections 40a of the manifold 28a include an SAE female threaded connector, thereby allowing the supply hoses 30a to be connected to the manifold 28a.

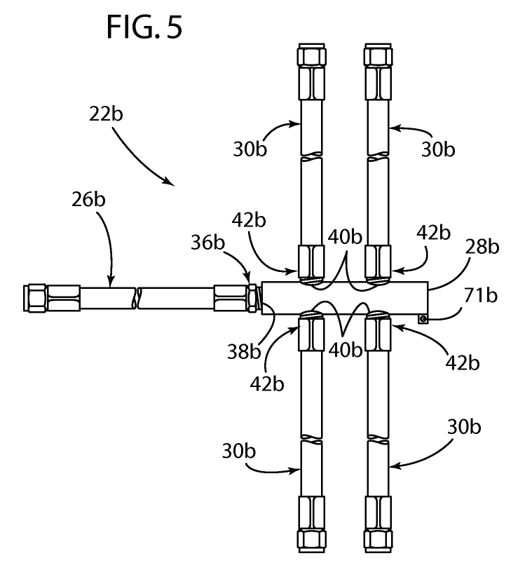

The reference numeral 22b (FIG. 5) generally designates another embodiment of the present invention, having a third embodiment for the gas delivery system. Since gas delivery system 22b is similar to the previously described gas delivery system 22, similar parts appearing in FIGS. 2, 2a and 3 and FIG. 5, respectively, are represented by the same, corresponding reference number, except for the suffix “b” in the numerals of the latter. In the third embodiment of the gas delivery system 22b, the inlet connection 38b and the outlet connection 40b of the manifold 28b include molded in metal (e.g., brass and steel) inserts having a hose barb, an SAE male threaded connector or internal National Pipe Tapered (NPT) (male or female) threads instead of barbs. Therefore, the second end 36b of the inlet hose 26b would include a threaded inlet for accepting the hose barb, an SAE female threaded connector or a NPT male or female threaded connector, thereby allowing the inlet hose 26b to be connected to the manifold 28b. Likewise, the first end 42b of the supply hoses 30b would include a threaded inlet for accepting the hose barb, an SAE female threaded connector or an NPT male or female threaded connector, thereby allowing the supply hoses 30b to be connected to the manifold 28b. It is also contemplated that the hoses 26b and 30b could have the molded inserts instead of the manifold 28b or in addition to the manifold 28b.

Accordingly, the gas delivery system of the present invention allows a user of a recreational vehicle or other apparatus using the gas delivery system to customize the entire system according to the delivery requirements for each appliance and for the overall recreational vehicle gas needs. For example, if an appliance only requires 2,000 BTU/hour, the gas delivery system of the present invention can utilize small diameter hoses to accommodate this reduced demand. Conversely, if the appliance requires a higher BTU capacity, a larger hose can be used. Additionally, if a hose is replaced after the initial installation, an aspect of the present invention allows for removal and replacement of the old system and installation of the system of the present invention. Furthermore, all of the hose or manifold connections outlined above can use any of the connections (e.g., threaded barbs, SAE male/female connectors, integrally cast barbs, barb connectors, internal threads for barbs or threaded hoses, molded in metal connectors, etc.) either on the hoses or the manifolds (using the same connectors or different connectors in one gas delivery system).

The foregoing detailed description is considered that of a preferred embodiment only, and the particular shape and nature of at least some of the components in this embodiment are at least partially based on manufacturing advantages and considerations as well as on those pertaining to assembly and operation. Modifications of this embodiment may well occur to those skilled in the art and to those who make or use the invention after learning the nature of this preferred embodiment, and the invention lends itself advantageously to such modification and alternative embodiments. Therefore, is to be understood that variations and modifications can be made on the aforementioned structure without departing from the concepts of the present invention, and further it is to be understood that such concepts are intended to be covered by the following claims unless these claims by their language expressly state otherwise.

I claim:

1. A gas delivery system for a recreational vehicle comprising:
an inlet hose configured to be connected to a source of gas;
a manifold connected to the inlet hose;
a plurality of supply hoses connected to the manifold; and
a plurality of appliances configured to be positioned within the recreational vehicle, with each one of the appliances being connected to one of the supply hoses;
wherein gas can be supplied to each of the appliances via the inlet hose, the manifold and one of the supply hoses.

2. The gas delivery system of claim 1, wherein:
the supply hoses include a first hose having a first flow rate and a second hose having a second flow rate, the first flow rate being different than the second flow rate.

3. The gas delivery system of claim 1, wherein:
the manifold includes an inlet connection connected to the inlet hose and a plurality of outlet connections connected to the supply hoses.

4. The gas delivery system of claim 3, wherein:
the inlet connection is internally threaded to accept an end of the inlet hose for connecting the inlet hose to the manifold.

5. The gas delivery system of claim 3, wherein:
the outlet connections are internally threaded.

6. The gas delivery system of claim 5, wherein:
at least one of the supply hoses includes a first end having a threaded barb for insertion into one of the internally threaded outlet connections of the manifold.

7. The gas delivery system of claim 5, wherein:
at least one of the supply hoses includes an externally threaded end for insertion into one of the internally threaded outlet connections of the manifold.

8. The gas delivery system of claim 3, wherein:
the outlet connections include molded in metal inserts having a hose barb, an SAE male threaded connector or internal threads instead of barbs.

9. The gas delivery system of claim 1, wherein:
the manifold could include a grounding hole, wherein a conductive wire is configured to be connected to the grounding hole to help ground the manifold and thereby dissipate any charge that may develop within the manifold.

10. The gas delivery system of claim 1, further including:
a gas regulator connected to the inlet hose.

11. A recreational vehicle comprising:
a vehicle housing;
an inlet hose configured to be connected to a source of gas;
a manifold in the vehicle housing and connected to the inlet hose;
a plurality of supply hoses running through the vehicle housing, the plurality of supply hoses being connected to the manifold; and
a plurality of appliances positioned within the recreational vehicle, with each one of the appliances being connected to one of the supply hoses;
wherein gas can be supplied to each of the appliances via the inlet hose, the manifold and one of the supply hoses.

12. The recreational vehicle of claim 11, wherein:
the supply hoses include a first hose having a first flow rate and a second hose having a second flow rate, the first flow rate being different than the second flow rate.

13. The recreational vehicle of claim 11, wherein:
the manifold includes an inlet connection connected to the inlet hose and a plurality of outlet connections connected to the supply hoses.

14. The recreational vehicle of claim 13, wherein:
the inlet connection is internally threaded to accept an end of the inlet hose for connecting the inlet hose to the manifold.

15. The recreational vehicle of claim 13, wherein:
the outlet connections are internally threaded.

16. The recreational vehicle of claim 15, wherein:
at least one of the supply hoses includes a first end having a threaded barb for insertion into one of the internally threaded outlet connections of the manifold.

17. The recreational vehicle of claim 15, wherein:
at least one of the supply hoses includes an externally threaded end for insertion into one of the internally threaded outlet connections of the manifold.

18. The recreational vehicle of claim 13, wherein:
the outlet connections include molded in metal inserts having a hose barb, an SAE male threaded connector or internal threads instead of barbs.

19. The recreational vehicle of claim 11, wherein:
the manifold could include a grounding hole, wherein a conductive wire is configured to be connected to the grounding hole to help ground the manifold and thereby dissipate any charge that may develop within the manifold.

20. The recreational vehicle of claim 11, further including:
a gas regulator connected to the inlet hose.

21. A method of delivering gas in a recreational vehicle comprising:
providing an inlet hose;
connecting the inlet hose to a source of gas;
connecting a manifold to the inlet hose;
connecting a plurality of supply hoses to the manifold;
positioning a plurality of appliances within the recreational vehicle;
connecting each one of the appliances to one of the supply hoses; and
supplying gas to each of the appliances via the inlet hose, the manifold and one of the supply hoses.
